(19) United States
(12) Patent Application Publication
(10) Pub. No.: US 2026/0192655 A1
(43) Pub. Date: Jul. 9, 2026

(54) Off-Road Vehicle

(71) Applicant: Zhejiang CFMOTO Power Co., Ltd., Hangzhou (CN)

(72) Inventors: Xin Ai, Hangzhou (CN); Dong Ding, Hangzhou (CN); Chao Lin, Hangzhou (CN); Wei Han, Hangzhou (CN); Jia Li, Hangzhou (CN); Guangbing Zhu, Hangzhou (CN); Zhe Zhao, Hangzhou (CN)

(21) Appl. No.: 19/556,190

(22) Filed: Mar. 4, 2026

Related U.S. Application Data
(63) Continuation of application No. PCT/CN2024/114253, filed on Aug. 23, 2024.

(30) Foreign Application Priority Data
Sep. 4, 2023 (CN) 202311130855.1

(51) Int. Cl. B60K 11/08; B60J 5/04; B60K 5/12; B60K 11/04; B60K 13/02; B60K 13/04; B60K 15/063; B60K 17/06; B60K 17/16; B62D 63/04

(52) U.S. Cl. CPC B60K 11/08; B60K 5/12; B60K 11/04; B60K 13/02; B60K 13/04; B60K 15/063; B60K 17/06; B60K 17/16; B62D 63/04; B60J 5/04; B60K 2015/0637

(57) ABSTRACT

An off-road vehicle has a cooling system with a cooling module positioned above the prime mover assembly. An air-guide guides ambient air to the cooling module. Air chamber intake ports of the air-guide are positioned rearwardly and positioned further from the longitudinal mid-plane than the vehicle doors, such that doors guide air into and through the air chamber intake ports for airflow through the cooling module. The cooling module includes an intercooler, a radiator and a fan assembly, positioned against each other in that order so air is fanned through both the intercooler and radiator. The prime mover assembly is supported at least in part by a support cradle. A power package/cradle length ratio of the power package length to the support cradle length is in the range from 1.3 to 1.9.

### RELATED APPLICATION INFORMATION

The present application is a continuation of PCT/CN2024/114253, filed Aug. 23, 2024, and claims the benefit of priority to Chinese Patent Application No. 202311130855.1, entitled “Off-road vehicle”, filed with the Chinese Patent Office on Sep. 4, 2023. The entire contents of the above-referenced applications are incorporated herein by reference.

### FIELD OF THE DISCLOSURE

The present invention relates to the field of vehicles, and particularly to an off-road vehicle.

### BACKGROUND OF THE DISCLOSURE

Off-road vehicles are a type of vehicle with strong off-pavement performance and enjoyment, typically involving low pressure tires and high suspension travel, which are increasingly favored by consumers. Two types of off-road vehicles, SSVs (Side by Side Vehicles) and UTVs (Utility Vehicles), refer to vehicles with a cockpit which is at least semi-enclosed.

The cooling system is an important part of off-road vehicles, and cooling efficiency thereof has a significant impact on the power system of off-road vehicles. However, the cooling efficiency of the cooling system in the existing off-road vehicles can be relatively low, which makes it particularly difficult to meet the cooling requirements of off-road vehicles having large engine displacement and/or vehicles generating additional heat through a turbocharger.

### SUMMARY OF THE INVENTION

In order to address the shortcomings in the background, the purpose of the present invention is to provide an off-road vehicle with a cooling system that has high cooling efficiency.

To achieve the above objectives, the present invention adopts the following technical solution:

An off-road vehicle includes a frame, a plurality of wheels, a vehicle body cover, a prime mover assembly, a drive train, a cooling system, left and right vehicle doors, and an air-guide. The frame defines a cockpit and a longitudinal mid-plane of the off-road vehicle. The plurality of wheels support the frame through a suspension system. The vehicle body cover is arranged on the frame. The prime mover assembly is supported by the frame behind the cockpit. The drive train is coupled between the prime mover assembly and at least some of the plurality of wheels to provide torque to at least some of the plurality of wheels for movement of the off-road vehicle. The cooling system is supported by the frame and has a cooling module positioned above the prime mover assembly. The vehicle doors are connected to the frame and provide access to the cockpit. The air-guide guides ambient air to the cooling module. The air-guide includes an air-guiding housing and at least one air chamber intake port. The air-guiding housing has a rear chamber portion, with the cooling module at least partially positioned in the rear air chamber portion. The air chamber intake port is positioned rearwardly and positioned further from the longitudinal mid-plane than one of the left and right vehicle doors, such that the one of the left and right vehicle doors guides air into and through the air chamber intake port to provide air to the rear air chamber portion of the air-guiding housing for airflow through the cooling module.

In another aspect, the cooling module includes an intercooler, a radiator and a fan assembly. The radiator is positioned against the intercooler. The fan assembly is positioned to move air through both the intercooler and radiator.

In another aspect, the prime mover assembly has an engine with an intake port oriented forwardly. The prime mover assembly is supported from the frame at least in part by a support cradle having at least three hangers. A maximum longitudinal distance between elastic centers of the hangers of the support cradle is defined as a support cradle length. The off-road vehicle further has an air filter and a muffler. The air filter filters air for combustion in the engine, and has a front-most end. The muffler is connected to the engine by an exhaust pipe, and has a rear-most end. The longitudinal distance from the front-most end of the air filter to the rear-most end of the muffler is defined as a power package length. A power package/cradle length ratio of the power package length to the support cradle length is in the range from 1.3 to 1.9.

### BRIEF DESCRIPTION OF THE DRAWINGS

FIG. 1 is a front left perspective view of an off-road vehicle according to a preferred embodiment of the present invention;

FIG. 2 is a rear left perspective view of a prime mover assembly and exhaust system in a frame of the off-road vehicle of FIG. 1;

FIG. 3 is a front view of the front wheels, portion of the front frame and the front suspension (other than the front shock absorbers) of the off-road vehicle of FIG. 1;

FIG. 4 is a front left perspective view of an alternative embodiment of a front frame and portion of the mid frame together with a front drive shaft and front differential which can alternatively be used in the off-road vehicle of FIG. 1;

FIG. 5 is an enlargement of part 5 of FIG. 4;

FIG. 6 is a front left perspective view of the front differential of FIGS. 4 and 5;

FIG. 7 is a front left perspective view of the prime mover assembly and exhaust system of FIG. 2, showing the continuously variable transmission (CVT) in exploded view;

FIG. 8 is a right side view of the prime mover assembly and exhaust system of FIGS. 2 and 7, relative to portions of the frame of FIG. 2 and a rear seat;

FIG. 9 is a top view of the hanger connection structure of the prime mover assembly relative to the bottom portion of the rear frame of FIG. 2;

FIG. 10 is a rear right perspective view, in partial cross-section, of a preferred fuel tank for use in the off-road vehicle of FIG. 1;

FIG. 11 is a perspective view of the filler pipe used in the fuel tank of FIG. 10.

FIG. 12 is a front right perspective view of an alternative fuel tank and alternative fuel system layout relative to the frame of FIG. 2;

FIG. 13 is a right side view of the cooling module (shown without the cooling module fixing bracket), engine and alternative fuel tank relative to the frame, seats and wheels of the off-road vehicle of FIG. 1;

FIG. 14 is a right side view of the cooling module of FIG. 13, shown without the cooling module fixing bracket;

FIG. 15 is a top plan view of the cooling module of FIGS. 13 and 14, shown with the cooling module fixing bracket;

FIG. 16 is a top plan view of the cooling module of FIGS. 13-15 relative to the frame, seats and wheels of FIGS. 1 and 13;

FIG. 17 is a front view of a cooling module fixing bracket for the cooling module of FIGS. 13-16;

FIG. 18 is a top plan view of an air guide housing for use in the off-road vehicle of FIG. 1;

FIG. 19 is a left side view of the full air-guide, including the air-guide housing of FIG. 18, relative to the CVT of FIGS. 2 and 7 and relative to an alternative air filter;

FIG. 20 is a front elevational view of the full air-guide of FIGS. 18 and 19; and

FIG. 21 is a top plan view of a preferred coolant reservoir for use in the off-road vehicle of FIG. 1.

### DETAILED DESCRIPTION

In order to enable personnel in this field to better understand the present invention, the technical solutions in specific embodiments of the present invention will be clearly and completely described below in conjunction with the accompanying drawings.

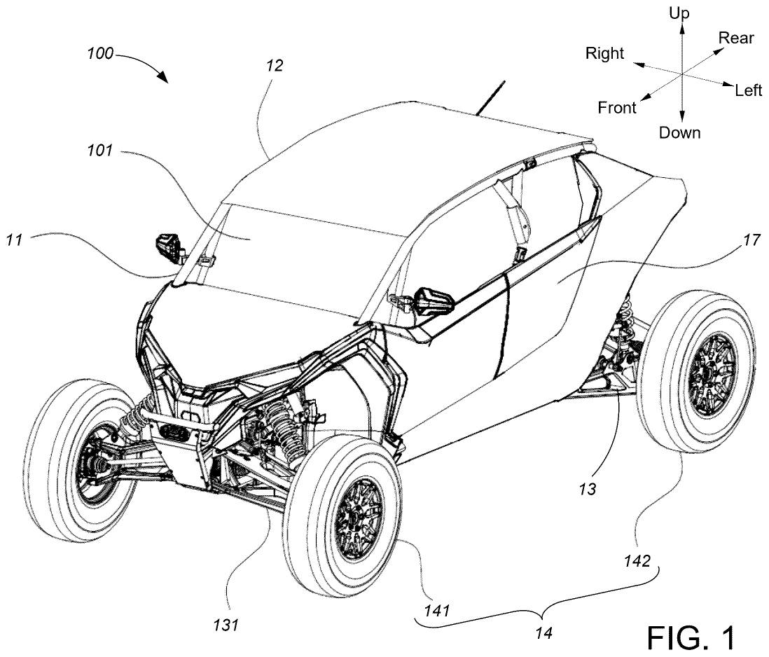

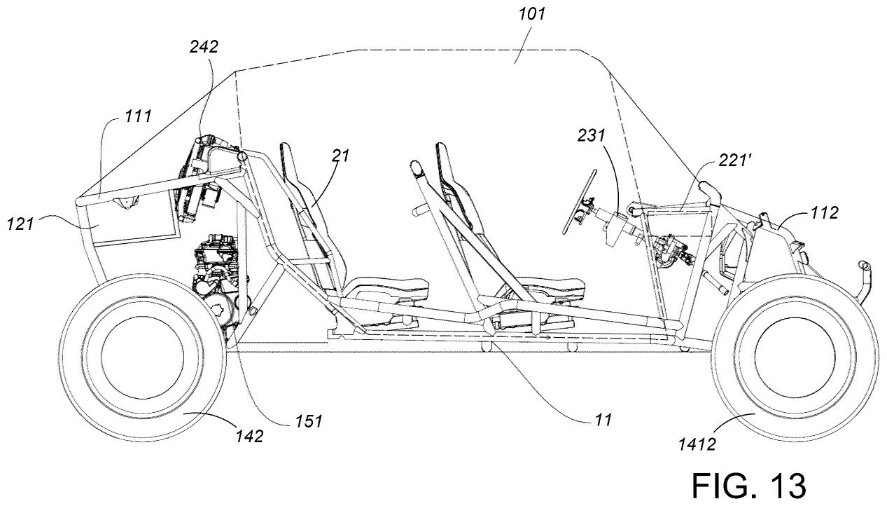

The present invention provides an off-road vehicle 100 such as shown in FIG. 1, which includes a frame 11, a vehicle body cover 12, a suspension system 13, and a plurality of wheels 14. The frame 11 forms the main support structure of the off-road vehicle 100. The frame 11 and the vehicle body cover 12 cooperatively define a cockpit 101 having seats 21 (such as shown in FIG. 13) for a driver and preferably at least one passenger. Other systems and components are directly or indirectly connected to the frame 11. The vehicle body cover 12 is at least partially positioned on an outer side of the frame 11, and used to cover most of the frame 11. The suspension system 13 connects the plurality of wheels 14 to the frame 11 so as to support the frame 11.

For better understanding of the present invention, orientations of “front”, “rear”, “left”, “right”, “up”, and “down” are shown in FIG. 1. In the description of the present invention, it should be noted that the terms “length direction”, “longitudinal” and reference numerals beginning with “L” refer to a front-rear direction of the vehicle 100, the terms “width direction”, “lateral”, “transverse” and reference numerals beginning with “W” refer to a left-right direction of the vehicle 100, and the terms “height direction”, “vertical” and reference numerals beginning with “H” refer to an up-down direction of the vehicle 100, all generally considering the vehicle 100 to be on flat ground and headed forward.

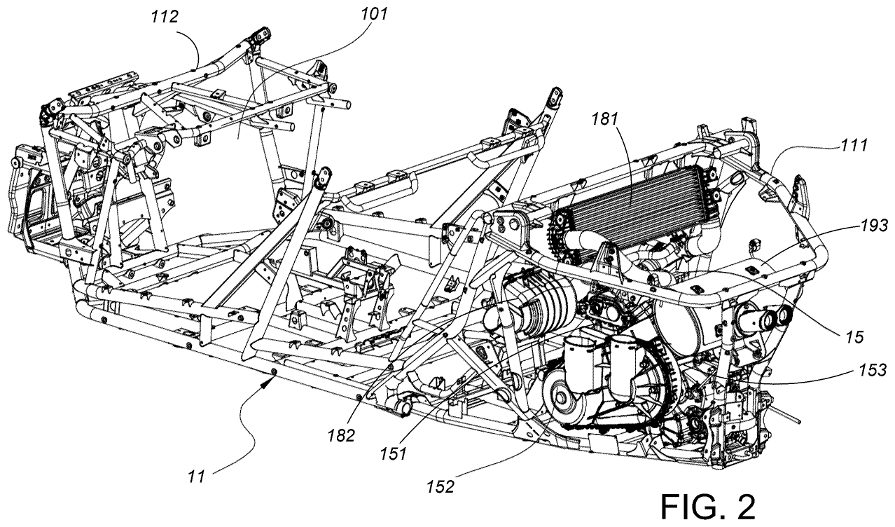

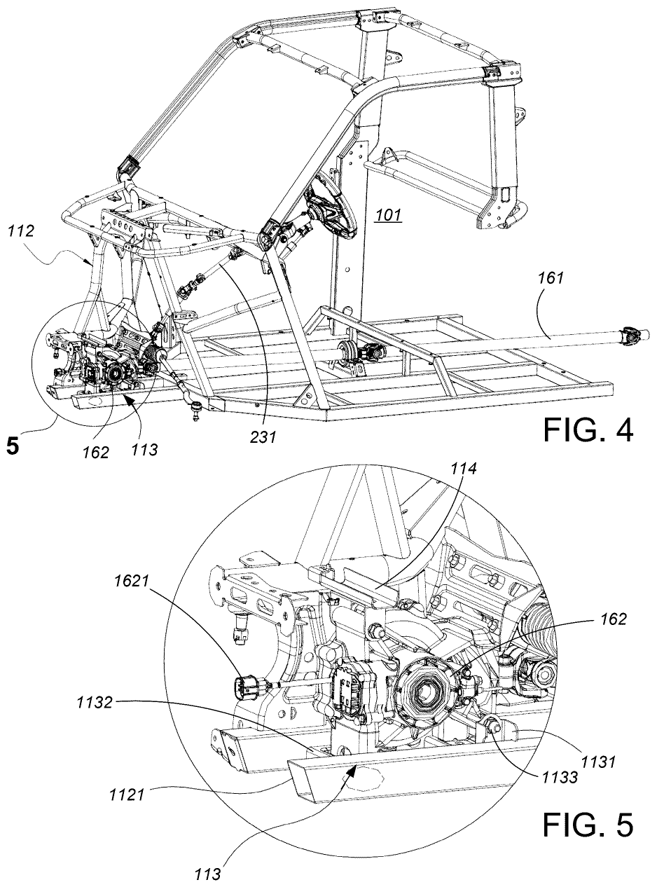

As shown in FIG. 2, the off-road vehicle 100 further includes a prime mover assembly 15 supported by the frame 11. The prime mover assembly 15 provides driving force for off-road vehicle 100. The off-road vehicle 100 has a drive train 16 (partially shown in FIG. 4) supported by the frame 11. The drive train 16 is coupled to the prime mover assembly 15 in a transmission mode, so as to transmit driving force output from the prime mover assembly 15 to the wheels 14 to drive the off-road vehicle 100 to move. The frame 11 includes a portion behind the cockpit 101 defined as a rear frame 111, and the prime mover assembly 15 is preferably at least partially arranged on the rear frame 111. As called out in FIG. 1, the plurality of wheels 14 include front wheels 141 and rear wheels 142. The off-road vehicle 100 further preferably includes at least two vehicle doors 17 on left and right sides of the off-road vehicle 100. The off-road vehicle 100 shown in FIG. 1 is an SSV (Side by Side Vehicle), but may alternatively be another type of off-road vehicle including a UTV (Utility Vehicle).

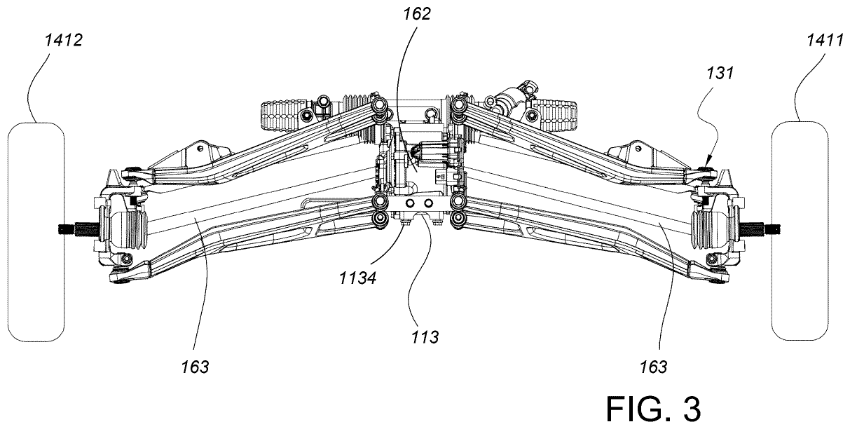

The suspension system 13 includes a front suspension 131, with a preferred front suspension 131 shown in FIG. 3. The front wheels 141 include a left front wheel 1411 arranged on a left side of the frame 11 and a right front wheel 1412 arranged on a right side of the frame 11. Both the left front wheel 1411 and the right front wheel 1412 are connected to a front frame 112 of the frame 11 by means of the front suspension 131.

The drive train 16 includes a front drive shaft 161 and a front differential 162 as shown in FIG. 4. The rear end of the front drive shaft 161 is coupled to the prime mover assembly 15 and the front end of the front drive shaft 161 is coupled to the front differential 162. The front drive shaft 161 is rotatably mounted so as to transmit power output from the prime mover assembly 15 to the front differential 162.

The drive train 16 further includes left and right front half shafts 163 as shown in FIG. 3. The front differential 162 can transmit power to the left and right front wheels 1411, 1412 through the respective left or right half shaft 163, thereby driving the front wheels 141 to rotate.

The front differential 162 preferably includes an electrical motor (not separately shown, but receiving electricity through an electric wire harness 1621), which can be positioned inside the case of the front differential 162, used to switch the differential 162 between a differential state and a locked state. In the differential state, the left front wheel 1411 and the right front wheel 1412 can rotate at different speeds, reducing wear of the left front wheel 1411 and/or the right front wheel 1412 (particularly the tires of the front wheels 141) during turning. In the locked state, the left front wheel 1411 and the right front wheel 1412 rotate at the same speed, eliminating the possibility of 100% of the front drive shaft torque spinning only one of the left front wheel 1411 and the right front wheel 1412 while that wheel 1411 or 1412 is freely spinning and the other wheel 1412 or 1411 is resisting spinning due to engagement with the ground or an obstacle.

The front frame 112 preferably includes a front axle mount 113 best understood with reference to FIGS. 4-6, for supporting the front differential 162 and securing the front differential 162 to the front frame 112. The front axle mount 113 preferably includes left and right rear mounting ears 1131 each fixed such as by welding to respective left and right longitudinal beams 1121 of the front frame 112, as well as a front mounting crossbar 1132 fixed such as by welding and running transversely between the left and right longitudinal beams 1121. At least one rear fastener 1133 secures the rear end of the front differential 162 by extending through the rear mounting ears 1131 into mating rear fastener hole(s) 1622 in the front differential 162. At least one front fastener 1134 secures the front end of the front differential 162 by extending through the front mounting crossbar 1132 into mating front fastener hole(s) 1623 in the front differential 162. The connection direction of the rear fastener(s) 1133 is substantially transverse, while the connection direction of the front fastener(s) 1134 is substantially vertical.

When mounting the front differential 162, it is necessary to push the front differential 162 longitudinally rearward relative to the front drive shaft 161. The preferred front axis mount 113 allows longitudinal movement of the front differential 162 during vehicle assembly without interference between the front differential 162 and the front axle mount 113, thereby reducing the difficulty of mounting the front differential 162. The rear fastener(s) 1133 and the front fastener(s) 1134 are preferably bolts or screws, etc.

The rear mounting ears 1131 are preferably formed from sheet metal, each providing a mounting face which is substantially perpendicular to the width direction of the off-road vehicle 100. The front differential 162 extends transversely between the mounting faces of the left and right rear mounting ears 1131. A substantial contact area between the front differential 162 and the rear mounting ears 1131 increases connection strength between the front differential 162 and the rear mounting ears 1131, thereby improving connection stability between the front differential 162 and the front axle mount 113.

The front mounting crossbar 1132 includes vertically extending bolt holes for the front fastener(s) 1134. During assembly, the front mounting crossbar 1132 can support the weight of the front differential 162 during rearward sliding until the rear fastener(s) 1133 can be inserted through the mounting ears 1131 and into the rear hole(s) 1622 and the front fastener(s) 1134 can be inserted through the bolt hole(s) in the front mounting crossbar 1132 and into the front hole(s) 1623, thereby reducing the assembly difficulty of the front differential 162 and improving the mounting efficiency of the front differential 162.

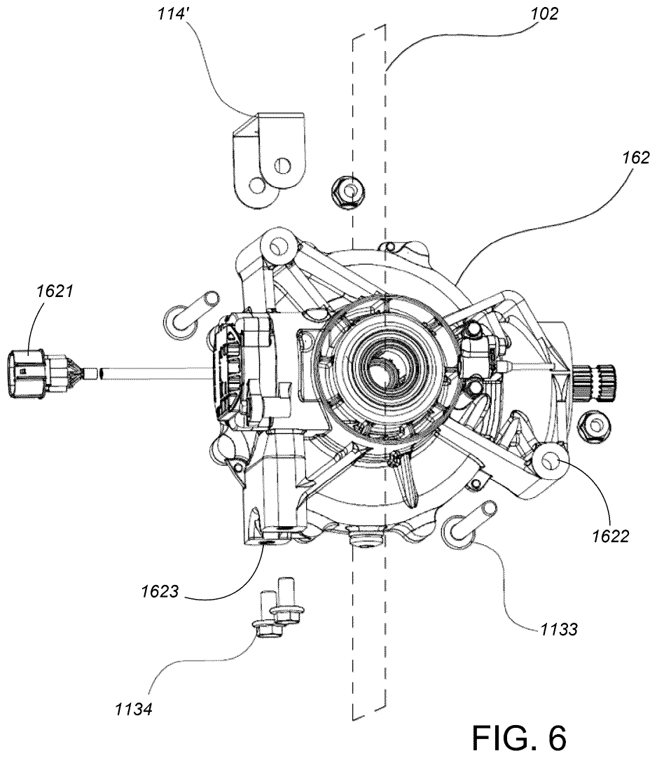

The frame 11 further includes a front axle adapter bracket 114, 114′ at least partially arranged above the front differential 162, with two different embodiments shown in FIGS. 5 and 6. The front axle adapter bracket 114, 114′ is detachably connected to the front differential 162 so as to extend upwardly therefrom. In side view, the front axle adapter bracket 114, 114′ is at least partially positioned forward of the front half shafts 163. A front differential center plane 102 can be defined as a plane perpendicular to the length direction of the off-road vehicle 100 and centered through the connection points between the front differential 162 and the half shafts 163. In side view, the front axle adapter bracket 114, 114′ is at least partially in front of the front differential center plane 201. This location for the front axle adapter bracket 114, 114′ avoids interference between the front axle adapter bracket 114, 114′ and other drive train and/or front suspension and/or steering components (such as a pull rod, steering gear, or the like, not shown). This location for the front axle adapter bracket 114, 114′ also makes load distribution of the front differential 162 uniform, improving the stability of the off-road vehicle 100. The front axle adapter bracket 114, 114′ can be used to attach other components (not shown) between the front differential 162 and the front frame 112, further improving connection strength between the front differential 162 and the front frame 112, thereby enhancing the stability of the front differential 162.

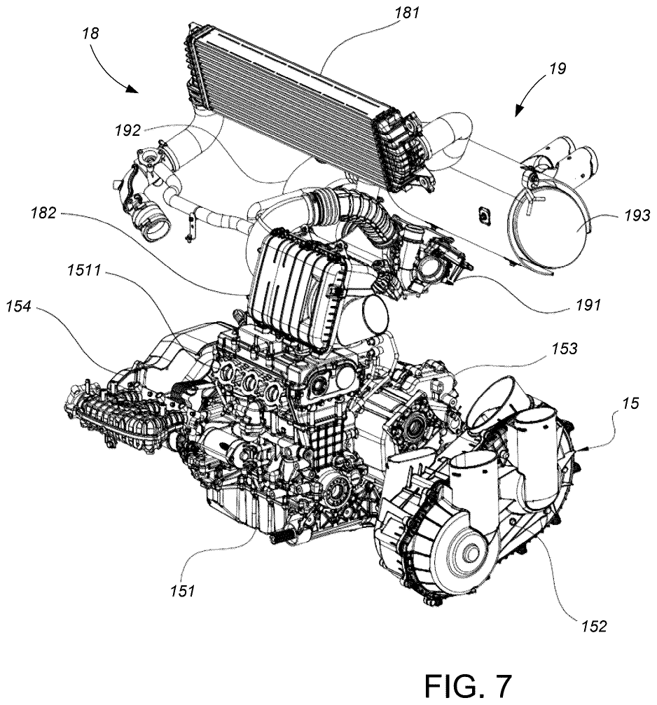

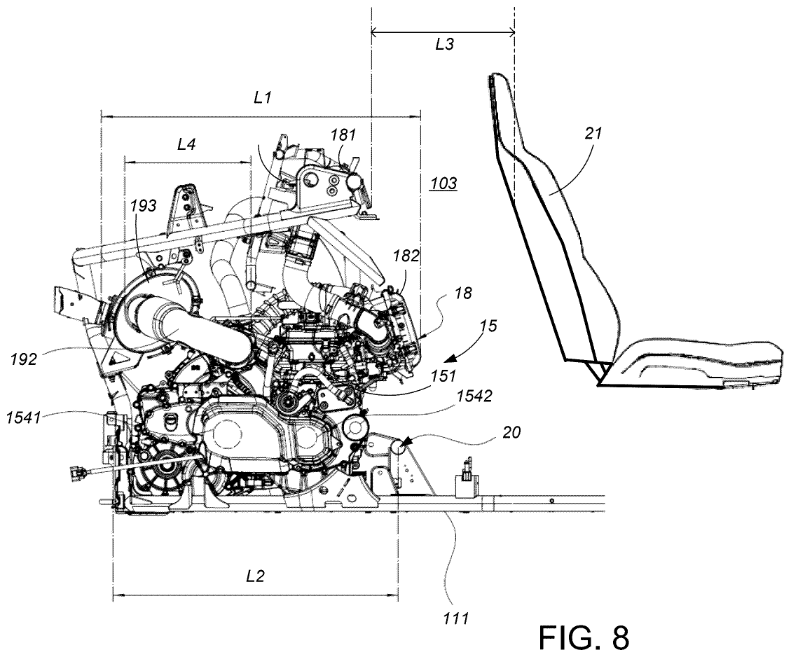

The off-road vehicle 100 includes an engine 151 for providing torque, a transmission 152 to reduce rotational speed at a varying speed ratio such as a continuously variable transmission (“CVT”), and a gearbox 153 which allows P-R-N-D-L shifting, preferably all provided as part of the prime mover assembly 15. As best shown in FIGS. 7 and 8, the off-road vehicle 100 preferably further includes an auxiliary drive system 154 coupled to the engine 151 and included as part of the prime mover assembly 15. The CVT 152 and the auxiliary drive system 154 are respectively arranged on the left and right sides of the engine 151 and connected to respective left and right ends of the crankshaft (not separately shown) of the engine 151. The engine 151 drives both the CVT 152 and the auxiliary drive system 154. The gearbox 153 is preferably mounted behind the engine 151 and is coupled to an output shaft (not separately shown) of the CVT 152.

The engine 151 defines an intake port 1511 and an exhaust port (not separately shown), preferably oriented with the intake port 1511 facing the front of the off-road vehicle 100 and the exhaust port located rearward of the intake port 1511 and facing the rear of the off-road vehicle 100. The off-road vehicle 100 includes a combustion air handling system 18 and an exhaust system 19. The exhaust system 19 includes a turbocharger 191 receiving exhaust from the exhaust port as well as an exhaust duct or pipe 192 and a muffler 193. The turbocharger 191 uses exhaust flow to increase pressure of incoming combustion air. The muffler 193 is used to reduce engine noise from the high-temperature and high-pressure gases emitted from the exhaust port. Longitudinally, the turbocharger 191 is at least partially positioned between the engine 151 and the gearbox 153, thereby improving the compactness of the entire vehicle 100. With this location for the turbocharger 191, the impact of high-temperature and high-pressure gases emitted by the engine 151 on the cockpit 101 can be reduced, thereby improving the comfort of the environment inside the cockpit 101.

The combustion air handling system 18 includes an intercooler 181 and an air filter 182. The intercooler 181 is used to reduce the combustion air intake temperature of the engine 151, improving working efficiency and operational stability of the engine 151. The intercooler 181 is at least partially positioned above the engine 151 and behind the seats 21 (shown in FIGS. 8, 13 and 16). The air filter 182 is used to filter air prior to combustion, and air filter 182 is connected to the intake port 1511 of the engine 151 through the turbocharger 191 and intercooler 181. In side view, the air filter 182 is at least partially positioned in front of the engine 151. The external shape of the air filter 182 is insignificant, and various external air filter shapes are depicted. The longitudinal distance between the front-most end of the air filter 182 and the rear-most end of the muffler 193 is defined as a power package length L1 as shown in FIG. 8.

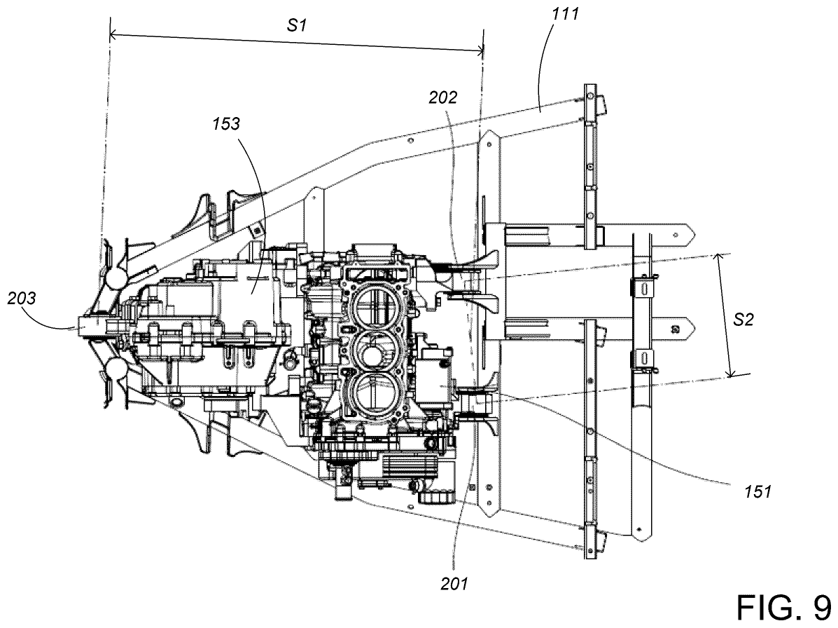

The prime mover assembly 15 is connected to the rear frame 111 by a support cradle 20. As best shown in FIG. 9, the support cradle 20 preferably includes three hangers such as a front-right hanger 201, a front-left hanger 202 and a rear hanger 203. The front hanger(s) 201, 202 are toward the front side of the prime mover assembly 15, and the rear hanger(s) 203 is toward the rear side of the prime mover assembly 15. Further, no two of the hangers 201, 202, 203 are at the same longitudinal position on the off-road vehicle 100, and no two of the hangers 201, 202, 203 are at the same lateral position on the off-road vehicle 100. In the preferred embodiment, the front-right hanger 201 is positioned further forward than either the front-left hanger 202 or the rear hanger 203, and the rear hanger 203 is positioned further rearward than either of the front hangers 201, 202, such that the front-right hanger 201 and the rear hanger 203 have a maximum hanger spacing S1 between them. The front hangers 201, 202 have a minimum hanger spacing S2 between them. In the preferred embodiment, the maximum hanger spacing S1 is preferably two to four times as long as the minimum hanger spacing S2, and more preferably about three times as long as the minimum hanger spacing S2. The maximum longitudinal distance between elastic centers of the hangers 201, 202, 203 of the support cradle 20 is defined as a support cradle length L2 as called out in FIG. 8.

A power package/cradle length ratio L1/L2 of the power package length L1 to the support cradle length L2 is preferably in the range from 1.3 to 1.9, more preferably in the range from 1.4 to 1.7, and most preferably about 1.6. If the power package/cradle length ratio L1/L2 is too large, the support cradle 20 is unable to adequately support the prime mover assembly 15 from tilting forwardly or rearwardly, which affects the stability of the connection between the prime mover assembly 15 and the rear frame 111. If the power package/cradle length ratio L1/L2 is too small, then vertical movement of the prime mover assembly 15 relative to the frame 11 can become excessive. By having power package/cradle length ratio L1/L2 with the preferred values, the rationality of the layout of the prime mover assembly 15 has been improved, ensuring the support effect of the support cradle 20 on the prime mover assembly 15, thereby enhancing the stability of the prime mover assembly 15.

In the preferred embodiment, an intercooler air circulation space 103 is defined in front of the intercooler 181, between the intercooler 181 and the seats 21 as called out in FIG. 8. The intercooler air circulation space 103 has an intercooler air circulation space length L3, measured longitudinally between the forwardmost edge of the intercooler 181 and the back of the seats 21 at the same elevation as the forwardmost edge of the intercooler 181. The intercooler air circulation space length L3 is preferably in the range from 128 mm to 284 mm, more preferably in the range from 140 mm to 256 mm, and most preferably in the range from 152 mm to 228 mm. If the intercooler air circulation space length L3 is too large, the intercooler 181 may be too far rearward so as to interfere with the muffler 193, or the seats 21 may be too far forward so as to affect the comfort of passengers. If the intercooler air circulation space length L3 is too small, heat dissipation of the intercooler 181 may be adversely affected. In addition, by having preferred values for the intercooler air circulation space length L3, the rationality and compactness of the layout can be improved while ensuring the performance of the intercooler 181.

The exhaust duct 192 runs from the turbocharger 191 to the muffler 193, having an exhaust duct length L4 measured in the longitudinal direction. A power package/exhaust duct length ratio L1/L4 of the power package length L1 to the exhaust duct length L4 is preferably in the range from 0.3 to 0.5, more preferably in the range from 0.35 to 0.45, and most preferably 0.4. If the power package/exhaust duct length ratio L1/L4 is too large, the exhaust pipe length L4 is too long and the exhaust duct 192 occupies too much layout space, which reduces the compactness of the off-road vehicle 100. If the power package/exhaust duct length ratio L1/L4 is too small, the distance between the muffler 193 and the engine 151 is too short, which makes it difficult to arrange wiring harnesses (not shown) around the engine 151. By having a preferred value for the power package/exhaust duct length ratio L1/L4, it is convenient to arrange wiring harnesses around the engine 151 while also improving the compactness of the off-road vehicle 100.

The auxiliary drive system 154 includes a primary alternator 1541 and an auxiliary generator 1542. The primary alternator 1541 is connected to the crankshaft of the engine 151, and always generates electricity when the engine 151 is working. The auxiliary generator 1542 is coupled to the primary alternator 1541 in a transmission mode. When electricity consumption of the off-road vehicle 100 is low, the auxiliary generator 1542 maintains a low-speed state, and the primary alternator 1541 by itself meets the electric demand of the off-road vehicle 100. When electricity consumption of the off-road vehicle 100 is greater than or equal to the preset threshold, the auxiliary generator 1542 switches to a power generation state to assist the primary alternator 1541 in meeting the electricity demand of the off-road vehicle 100. Through the above arrangement, while meeting the electricity demand of the off-road vehicle 100, it is also possible to avoid damage to the auxiliary generator 1542 caused by prolonged use, thereby extending the service life of the auxiliary generator 1542. The primary alternator 1541 is preferably a permanent magnet motor, and the auxiliary generator 1542 is preferably an excitation motor.

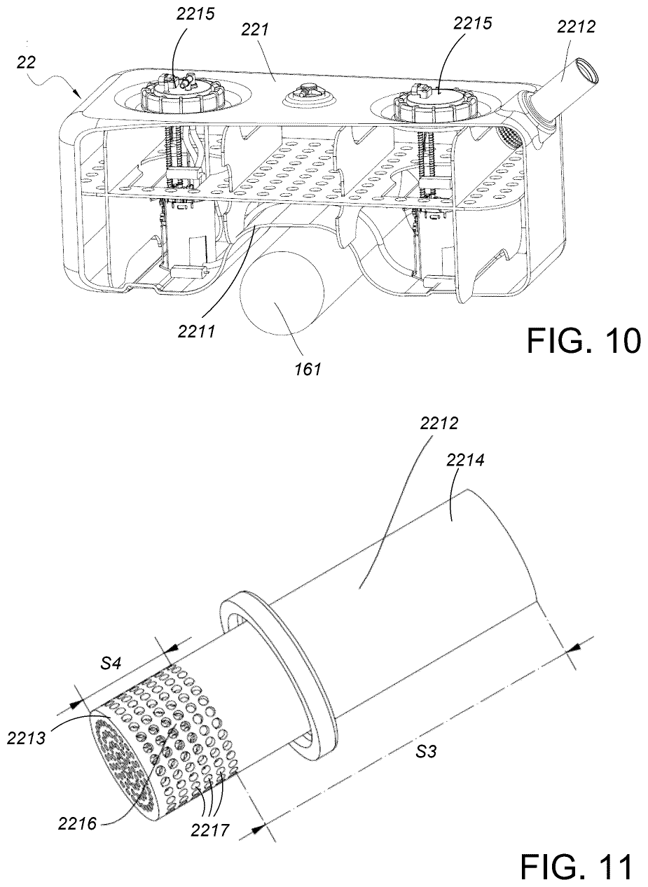

The off-road vehicle 100 further includes a fuel system 22 arranged on the frame 11. The fuel system 22 is at least partially connected to the prime mover assembly 15 and provides fuel for the engine 151. The fuel system 22 includes a fuel tank 221 shown relative to the front drive shaft 161 in FIG. 10. The fuel tank 221 defines a longitudinally-extending saddle-shaped depression 2211, and the front drive shaft 161 extends through the saddle-shaped depression 2211. In both side and plan views, at least a portion of the front drive shaft 161 overlaps with the fuel tank 221. In the preferred embodiment, the saddle-shaped depression 2211 faces downwardly. Positioning a portion of the front drive shaft 161 in the saddle-shaped depression 2211 of the fuel tank 221 allows for more ground clearance below the front drive shaft 161 while balancing weight distribution of fuel in the off-road vehicle 100 in the width direction. Positioning a portion of the front drive shaft 161 in the saddle-shaped depression 2211 of the fuel tank 221 also allows for more compact placement of the seats 21, improving overall space utilization rate.

The fuel tank 221 includes a filler pipe 2212 for refueling, and the filler pipe 2212 is further shown in FIG. 11. A bottom end 2213 of the filler pipe 2212 extends into the fuel tank 221, and a top end 2214 of the filler pipe 2212 is exposed outside the fuel tank 221, for access outside the vehicle body cover 12 either directly or through an extension tube (not shown). Longitudinally, the filler pipe 2212 is preferably positioned toward the front of the fuel tank 221. The filler pipe 2212 has a function of guiding and controlling the direction of insertion of a fuel gun (not shown) and/or the direction of fuel flow during refueling. The preferred fuel tank 221 includes two fuel pumps 2215, one on each side of the saddle-shaped depression 2211. Each of the two fuel pumps 2215 extends downwardly to an elevation below a top of the saddle-shaped depression 2211 and below a top of the front drive shaft 161. Correct placement and orientation of the bottom end 2213 of the filler pipe 2212 also protects the fuel pumps 2215 and any other components in the fuel tank 221, preventing damage to the fuel pumps 2215 due to collision with either the fuel gun or pressurized fuel flow during refueling.

The preferred filler pipe 2212 includes a strainer 2216 on its bottom end 2213. On one hand, the strainer 2216 can prevent external devices from entering the fuel tank 221 to steal fuel. On the other hand, the strainer 2216 can filter impurities in the fuel. The strainer 2216 can directly block impurity particles in the filler pipe 2212, thereby preventing impurities from entering the fuel tank 221 and avoiding impurities in the fuel from blocking the fuel system 22. The filler pipe 2212 has an unperforated filler pipe length S3, and the strainer 2216 has a strainer length S4, both measured in the axial direction of the filler pipe 2212. A strainer length ratio S4/S3 of the strainer length S4 to the unperforated filler pipe length S3 is preferably in the range from 0.1 to 0.5, more preferably from 0.15 to 0.45, and most preferably from 0.2 to 0.4. The strainer 2216 preferably has a plurality of circular strainer holes 2217. The aperture (diameter when circular) of each strainer hole 2217 is preferably in the range from 2.5 to 5 mm, more preferably from 3 to 4.5 mm, and most preferably from 3.5 to 4 mm. Correct sizing of the strainer holes 2217 within the preferred value ranges ensures that the vast majority of particulate impurities are blocked away from the fuel pumps 2215 without overly restricting fuel flow. Correct shaping and spacing of the strainer holes 2217 enhances strength of the strainer 2216 while maintaining low manufacturing costs. The strainer holes 2217 may be integrally formed in the filler pipe 2212, or the strainer 2216 may be manufactured separately from the rest of the filler pipe 2212 and then assembled together. Separate manufacturing of the strainer 2216 and the rest of the filler pipe 2212 allows selection of a strainer 2216 with different dimensions, such as for different vehicle models or different use scenarios with different quality fuel supplies and/or different fuel theft risks, increasing the versatility of the strainer 2216. The preferred filler pipe 2212 may be removed from the fuel tank 221 to allow cleaning and/or replacement should the strainer holes 2217 become blocked by particulate impurities.

The fuel tank 221 is preferably positioned at the front of the cockpit 101, just over the drive shaft 161, but still behind the front differential 162. Positioning the fuel tank 221 at the front of the cockpit 101 places the fuel tank 221 far away from the engine 151, which can avoid heating of the fuel tank 221 and the fuel in the fuel tank 221, and improve the safety of the fuel tank 221. Positioning the fuel tank 221 at the front of the cockpit 101 can also expand the storage space in the cockpit 101 of the off-road vehicle 100.

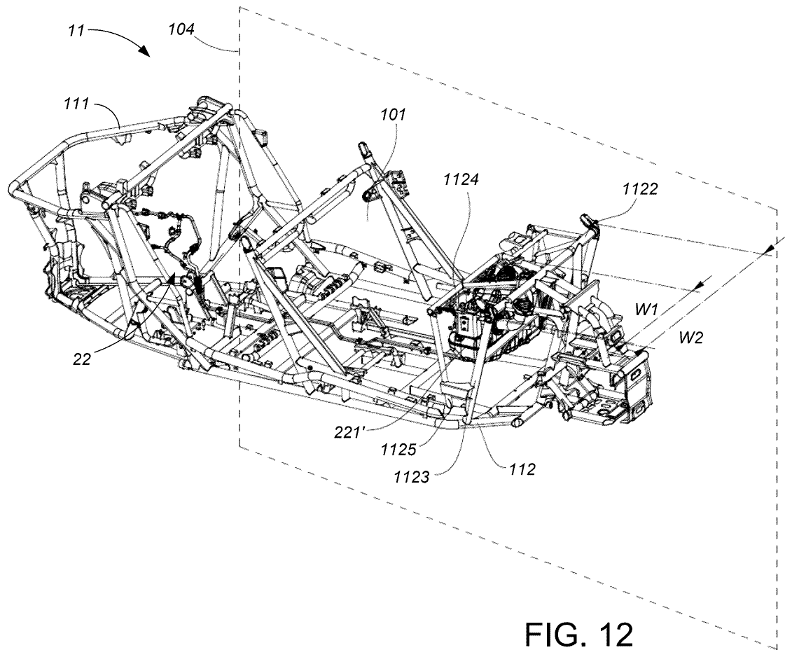

FIGS. 12 and 13 show an alternative fuel tank 221′ and alternative fuel system layout. The fuel tank 221′ is positioned longitudinally at the front of the cockpit 101, but is elevated well above the front drive shaft 161 (shown in FIGS. 4 and 10), so there is no need for the saddle-shaped depression 2211 nor for the second fuel pump 2215. To avoid interference with the steering column 231, the fuel tank 221′ is shifted toward being in front of the passenger seat of the off-road vehicle 100.

As called out in FIG. 12, the preferred front frame 112 includes an upper front crossbeam 1122 supported by left and right forward posts 1123, and an upper rear crossbeam 1124 supported by left and right rearward posts 1125. Both the upper crossbeams 1122, 1124 extend substantially transversely in the off-road vehicle 100. The forward posts 1123 preferably extend upwardly and forwardly, and the rearward posts 1125 preferably extend upwardly and rearwardly. The upper rear crossbeam 1124 is typically positioned just forward of a dashboard (not shown) of the off-road vehicle 100, demarking at least part of the front extent of the cockpit 101. The fuel tank 221′ is positioned longitudinally between the upper front crossbeam 1122 and the upper rear crossbeam 1124. The fuel tank 221′ is positioned elevationally just below the upper front crossbeam 1122 and the upper rear crossbeam 1124, at an elevation approximately equal to a top of the engine 151 or even fully above the top of the engine 151. The fuel tank 221′ is positioned laterally between the left and right forward posts 1123 and positioned laterally between the left and right rearward posts 1125. When the off-road vehicle 100 is impacted by external forces such as in a crash, the upper crossbeam 1122, the left and right forward posts 1123, the upper rear crossbeam 1124, and the left and right rearward posts 1125 provide protection for the fuel tank 221′, thereby avoiding damage to the fuel tank 221′ and improving its safety and service life.

As shown in FIG. 12, a longitudinal midplane 104 is defined as being perpendicular to the width direction of the off-road vehicle 100, centered between the left and right wheels 14. The fuel tank 221′ is positioned to at least partially extend across the longitudinal midplane 104, so the fuel weight does not overly unbalance the vehicle 100.

The fuel tank 221′ has a fuel tank width W1, and cockpit 101 has a cockpit width W2, both as called out in FIG. 12. A fuel tank width ratio W1/W2 of the fuel tank width W1 to the cockpit width W2 is preferably in the range from 0.5 to 0.8, more preferably in the range from 0.5 to 0.75, and most preferably in the range from 0.6 to 0.7. Values for fuel tank width ratio W1/W2 in the preferred ranges, together with offsetting the fuel tank 221′ toward the passenger side of the cockpit 101, helps leave space for mounting components such as the steering column 231 (shown in FIGS. 4, 13 and 16) of the off-road vehicle 100.

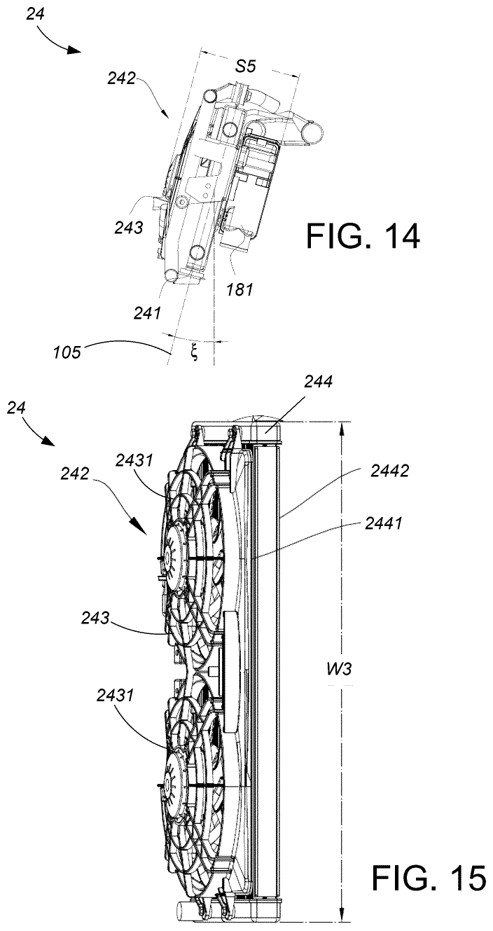

The off-road vehicle 100 includes a cooling system 24 for circulating coolant to remove heat from the engine 151. The cooling system 24 includes a radiator 241, and the preferred off-road vehicle 100 provides its radiator 241 as part of a cooling module 242 best shown in FIGS. 14-16. The cooling module 242 includes the radiator 241 and the intercooler 181, and further includes a fan assembly 243 including at least one fan 2431. The fan assembly 243 drives air flow through the intercooler 181 and the radiator 241, helping to carry heat away from the intercooler 181 and the radiator 241. In the preferred cooling module 242, the fan assembly 243 is positioned on a generally rear side of the radiator 241, while the intercooler 181 is positioned on a generally front side of the radiator 241. The cooling module 242 is connected to the rear frame 111 elevationally above the engine 151 and longitudinally behind the seats 21. Assembling and closely packing the intercooler 181, the radiator 241 and the fan assembly 243 into the cooling module 242 improves space utilization in the off-road vehicle 100. Shared usage of the fan assembly 243 by the intercooler 181 and the radiator 241 reduces electricity consumption of the off-road vehicle 100.

The preferred vehicle body cover 12 includes a cargo container 121 connected to the rear frame 111 in the position called out in FIG. 13. The cooling module 242 is positioned longitudinally in front of the cargo container 121, improving the space utilization rate of the off-road vehicle 100.

The cooling module 242 defines a cooling module plane 105 shown in FIG. 14, and the fans 2431 are preferably mounted with their rotational axes perpendicular to the cooling module plane 105. The cooling module 242 has a cooling module thickness S5 measured perpendicular to the cooling module plane 105, as well as a cooling module width W3. A cooling module aspect ratio S5/W3 of cooling module thickness S5 to cooling module width W3 is preferably in the range from 0.18 to 0.33, more preferably in the range from 0.2 to 0.3, and most preferably in the range from 0.23 to 0.28. When the value for cooling module aspect ratio S5/W3 is within the preferred range, cooling air volume is optimized while keeping the cooling module thickness S5 relatively small, increasing integration level of the cooling module 242.

A cooling module attack angle ξ is defined between the cooling module plane 105 and vertical, preferably with the fan assembly 243 blowing air rearwardly and upwardly. The cooling module attack angle ξ is preferably in the range from 5 to 30°, more preferably in the range from 10 to 25°, and most preferably in the range from 15 to 20°. Proper selection of cooling module attack angle ξ within the preferred range enhances air circulation and heat dissipation effect, without blowing hot air directly onto the muffler 193.

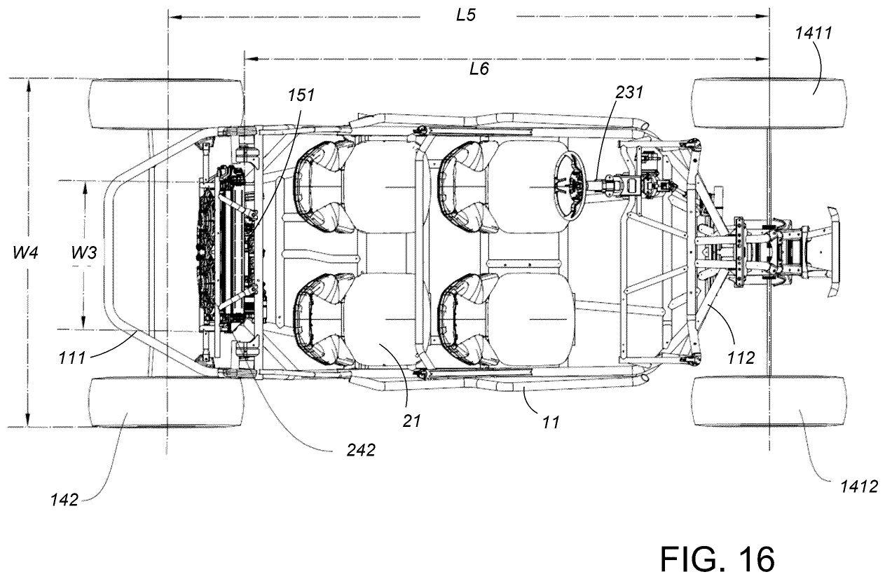

As shown in FIG. 16, a wheelbase L5 is defined as the longitudinal distance from a non-turning rotational axis of the front wheels 141 to a rotational axis of the rear wheels 142. A cooling module-front wheel distance L6 is defined as the longitudinal distance from the non-turning rotational axis of the front wheels 141 to the front-most end of the cooling module 242. A cooling module placement ratio L6/L5 of the cooling module-front wheel distance L6 to the wheelbase L5 is preferably in the range from 0.6 to 0.9, more preferably in the range from 0.65 to 0.85, and most preferably in the range from 0.7 to 0.8. Preferred values for cooling module placement ratio L6/L5 are beneficial for the weight distribution of the off-road vehicle 100.

An overall trackwidth W4 is defined as the distance between the outermost sidewalls of the two rear tires/wheels 142. A cooling module width ratio W3/W4 of the cooling module width W3 to the overall trackwidth W4 is preferably in the range from 0.39 to 0.72, more preferably in the range from 0.44 to 0.66, and most preferably in the range from 0.49 to 0.61. Preferred values for cooling module width ratio W3/W4 help to increase cooling efficiency without allowing the cooling module width W3 to become unwieldy in the overall layout.

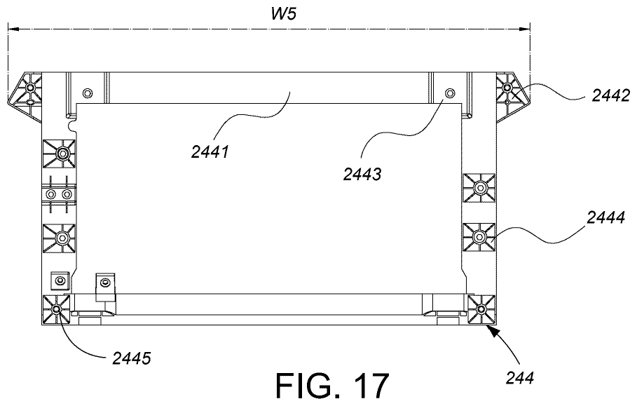

FIG. 17 shows a cooling module fixing bracket 244 preferably used for assembling the cooling module 242 and for securing the cooling module 242 to the rear frame 111. The cooling module fixing bracket 244 has a fan and radiator mounting surface 2441 and an intercooler mounting surface 2442. The fan assembly 243 and the radiator 241 are connected to the fan and radiator mounting surface 2441, with the radiator 241 positioned between the fan assembly 243 and the cooling module fixing bracket 244. The intercooler 181 is connected to the intercooler mounting surface 2442. The fan assembly 243, the radiator 241, and the intercooler 181 are pre-assembled together on the cooling module fixing bracket 244, prior to fixing the cooling module 242 as a unit into the off-road vehicle 100. Use of the cooling module fixing bracket 244 helps reduce the number of connection points into the frame 11 and improves mounting efficiency.

The cooling module fixing bracket 244 has a fixing bracket width W5, which is slightly larger than the cooling module width W3. In particular, a fixing bracket aspect ratio S3/W5 of cooling module thickness S3 to fixing bracket width W3 is slightly smaller than the cooling module aspect ratio S3/W5, namely preferably in the range from 0.16 to 0.32, more preferably in the range from 0.19 to 0.29, and most preferably in the range from 0.21 to 0.27. In side view, the radiator 241 overlaps with the cooling module fixing bracket 244, the radiator 241 arranged inside the cooling module fixing bracket 244 such that the cooling module fixing bracket 244 helps protect the radiator 241. In thickness or depth, the cooling module fixing bracket 244 is preferably 83 to 167% as thick as the radiator 241, more preferably 91 to 143% as thick as the radiator 241, and most preferably 100 to 125% as thick as the radiator 241.

As shown in FIG. 17, the fan and radiator mounting surface 2441 is provided with at least three fan mounting seats 2443 for fixing the fan assembly 243. The fan and radiator mounting surface 2441 is further provided with at least three radiator mounting seats 2444 for fixing the radiator 241. Installation of the fan assembly 243 and the radiator 241 on the cooling module fixing bracket 244 requires solid connection strength. By setting the fan mounting seats 2443 and the radiator mounting seats 2444 on the cooling module fixing bracket 244 respectively, the connection strength of the fan assembly 243 and the radiator 241 on the cooling module fixing bracket 244 is improved. The depth of the fan mounting seats 2443 relative to the fan and radiator mounting surface 2441 is greater than or equal to the depth of the radiator mounting seats 2444 relative to the fan and radiator mounting surface 2441, such that the fan assembly 243 is mounted outside the radiator 241, thereby making it easier for the fan assembly 243 to dissipate heat from the radiator 241. In the preferred embodiment, the radiator 241 includes tabs (not shown) that plug in to two of the radiator mounting seats 2444, while a fastener such as a bolt (not shown) through another of the radiator mounting seats 2444 is used to fix the radiator 241 to the cooling module fixing bracket 244 through the plug-in holes and the fixing holes. At least three connection seats 2445 are provided on the cooling module fixing bracket 244 for connecting the cooling module fixing bracket 244 to the rear frame 111, thereby fixing the cooling module 242 to the frame 11.

The cooling module fixing bracket 244 is preferably formed of rigid plastic having good corrosion resistance to chemicals such as acids or bases so as to extend the service life of the cooling module fixing bracket 244. The plastic used is lighter in weight than steel, helping reduce vehicle weight.

The off-road vehicle 100 preferably has an air intake system 25 to channel and direct exterior air. The air intake system 25 preferably channels and directs air to the air filter 182 for subsequent use in combustion, channels and directs air to the CVT 152 for cooling of the CVT 152, and channels and directs air to the cooling module 242 for cooling of coolant in the radiator 241 and for cooling of compressed air in the intercooler 181 for subsequent use in combustion in the engine 151.

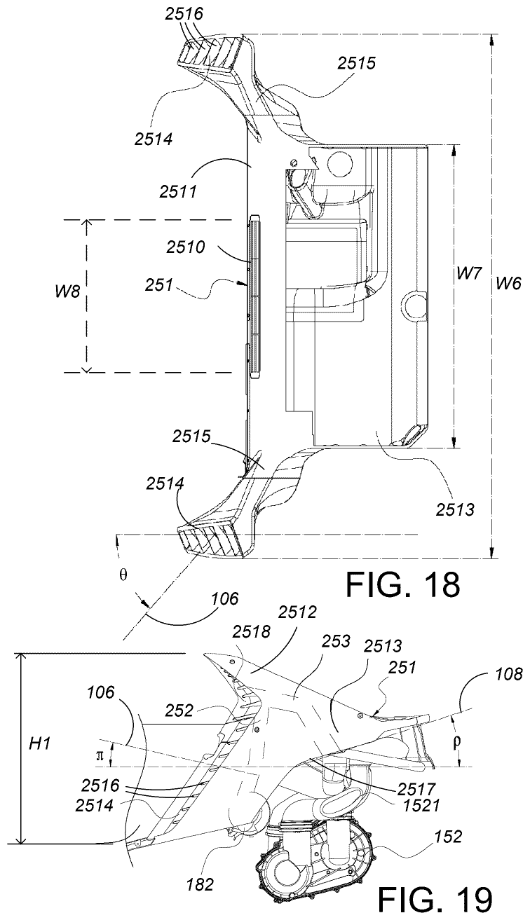

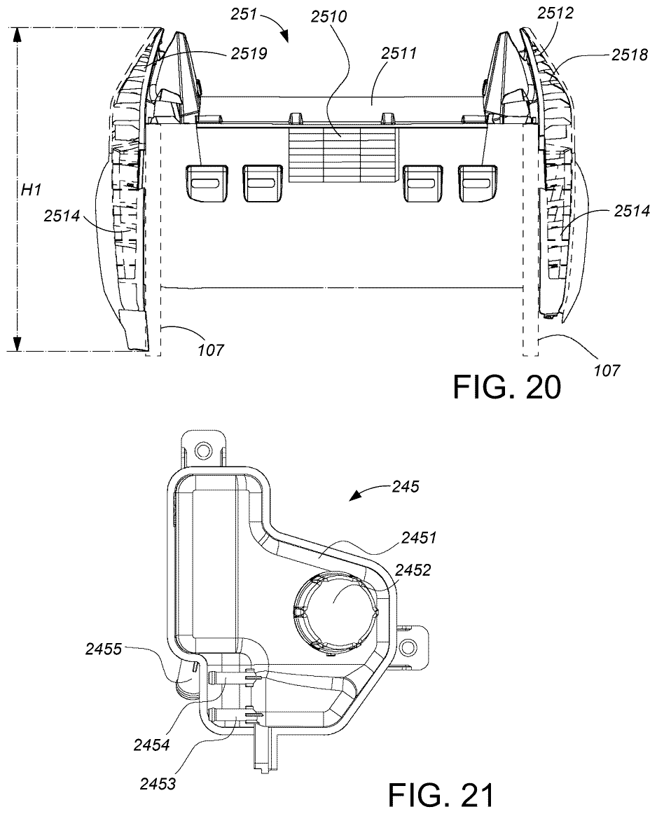

FIG. 18 shows a housing 2511 of, and FIGS. 19 and 20 show an entirety of, an air-guide 251 which can be used as part of a preferred air intake system 25. The housing 2511 of the air-guide 251 is used for guiding ambient air to and through the cooling module 242. In addition to the housing 2511, the air-guide 251 includes a ducting portion 2512 shown only in FIGS. 19 and 20. The ducting portion 2512 of the air-guide 251 connects to an air filter intake duct 252 for directing ambient air to the air filter 182 and a CVT intake duct 253 for directing ambient air to the CVT 152.

The air-guide 251 is mounted on the frame 11 at least partially behind the seats 21, extending across substantially the entire width of the off-road vehicle 100. The air-guide housing 2511 includes a rear air chamber portion 2513. For embodiments which use the air-guide 251, the cooling module 242 is at least partially positioned in the rear air chamber portion 2513.

The air-guide housing 2511 includes one or more preferably two air chamber intake ports 2514 on at least at one wide (left or right) end and more preferably on both left and right wide ends of the air-guiding housing 2511. The air chamber intake ports 2514 are positioned at the rear extent of the associated left or right door 17 (shown in FIG. 1 in an embodiment without the air-guide 251). The air chamber intake port(s) 2514 is/are in fluid communication with the interior of the rear air chamber portion 2513 through corresponding left/right air chamber intake ducts 2515.

During running of the off-road vehicle 100, the air-guide 251 guides airflow through the air chamber intake ports 2514 and corresponding air chamber intake ducts 2515 into the rear air chamber portion 2513 toward the cooling module 242. The air-guide 251 thus increases heat removal from the cooling module 242 of the off-road vehicle 100.

An intake extension line 106 is defined as an average between a centerline of the left or right air chamber intake duct 2515 and a direction perpendicular to the associated left or right air chamber intake port 2514. The air-guide 251 preferably includes multiple fixed, horizontally extending louvers 2516 to guide airflow and to strengthen the air-guide 251, with the preferred air-guide 251 having five of such louvers 2516 provided in each of the left and right air chamber intake ports 2514 as shown in FIG. 18. In the top plan view of FIG. 18, an air-guide longitudinal intake angle θ is defined between a horizontal component of the intake extension line 106 and the longitudinal direction. The air-guide longitudinal intake angle θ is preferably in the range from 30 to 70°, more preferably in the range from 40 to 65°, and most preferably in the range from 45 to 60°, i.e., most preferably initially directing air laterally inwardly in the air chamber intake duct 2515 as much or more as it moves longitudinally rearwardly in the air chamber intake duct 2515. In the side view of FIG. 19, an air-guide elevational angle π is defined between the intake port extension line 106 and horizontal. The air-guide elevational angle π is preferably in the range from 0 to 30°, more preferably in the range from 5 to 25°, and most preferably in the range from 10 to 20°, i.e., initially directing air through the air chamber intake ports 2514 before the air flows laterally inwardly and rearwardly in the air chamber intake duct 2515. The air-guide intake angles θ, π have a significant impact on air intake volume. When the air-guide intake angles θ, π have values within the preferred ranges, the air-guide 251 can better utilize air-guiding effect of the doors 17. At the same time, the orientation of the air chamber intake ports 2514 are also coordinated with the driving direction of the off-road vehicle 100, further increasing the air intake volume.

Air flows through the air chamber intake duct(s) 2515 to reach the interior of the rear air chamber portion 2513 and the cooling module 242. In plan view, the rear air chamber portion 2513 of the air-guiding housing 2511 at least partially overlaps with the prime mover assembly 15, with air flowing from the rear air chamber portion 2513 through the cooling module 242.

The air-guide 251 has an overall air-guide width W6. The rear air chamber portion 2513 of the air-guiding housing 2511 has an air chamber width W7. An air-guide width ratio W6/W7 of the overall air-guide width W6 to the an air chamber width W7 is preferably in the range from 1.1 to 2.2, more preferably in the range from 1.3 to 2.1, and most preferably in range from 1.5 to 1.9.

The doors 17 are positioned longitudinally fully forward of the air chamber intake ports 2514, thereby ensuring that the air-guide 251 does not interfere with opening and closing of the doors 17. In front view, the doors 17 are positioned substantially between the air chamber intake ports 2514 on both left and right sides. Left and right door skin edge areas 107 can be defined each as the smallest rectangular area which, in front view, contains the entire rear edge of the respective exterior door panel 17. As shown in FIG. 19, in front view the two door skin edge areas 107 are positioned between the two air chamber intake ports 2514. This arrangement keeps the air chamber intake ports 2514 from being blocked by the doors 17, and at the same time, the doors 17 can be used to deflect and guide air into the air chamber intake ports 2514, increasing air flow through the air-guide 251.

The air-guiding housing 2511 has an air-guide floor 2517 which is inclined rearwardly and upwardly. Space at the bottom of the air-guiding housing 2511 can be used as maintenance space for other components of the engine 151. An extension plane 108 of the air-guide floor 2517 has an air-guide floor angle ρ relative to horizontal. The air-guide floor angle ρ is preferably in the range from 10 to 30°, more preferably in the range from 17 to 22°, and most preferably in the range from 15 to 25°. The inclined air-guide floor 2517 helps direct air upwardly through the cooling module 242. If desired, a detachable cover plate (not shown) can be arranged through the air-guide floor 2517. Such a detachable cover plate can increase the maintenance convenience of the prime mover assembly 15 and related components located below the air-guiding housing 2511.

The ducting portion 2512 of the air guide 251 has a CVT duct inlet 2518 above one (for the depicted orientation of the prime mover assembly 15, preferably the left) of the air chamber intake ports 2514, and a combustion duct inlet 2519 above the other (for the depicted orientation of the prime mover assembly 15, preferably the right) of the air chamber intake ports 2514. The CVT intake duct 253 is connected to provide airflow from the CVT duct inlet 2518 to the CVT 152, providing cooling air for the CVT 152. The air filter intake duct 252 is connected to provide airflow from the combustion duct inlet 2519 to the air filter 182, which air is subsequently compressed in the turbocharger 191, cooled in the intercooler 181 and throttled before being used in the engine 151 for combustion. Positioning the CVT duct inlet 2518 and the combustion duct inlet 2519 above the air chamber intake ports 2514 helps intake of cleaner, drier air for cooling of the CVT 152 and for combustion than for flow through the cooling module 242, which can improve the operational stability of the CVT 152 and engine 151.

The air-guide 251 further includes one or more auxiliary air intake ports 2510 positioned at the front middle of the air-guiding housing 2511, behind the seats 21 and longitudinally rearward of the air chamber intake ports 2514. The auxiliary air intake 2510 has the function of supplementing the air intake ports 2514, but take air from inside the cockpit 101 rather than ambient air from outside the vehicle 100. In front view, the auxiliary air intake ports 2510 partially overlap with the seats 21, the top of the seats 21 being higher than the bottom of the auxiliary air intake ports 2510 but lower than the top of the auxiliary air intake ports 2510. The auxiliary air intake ports 2510 preferably have an auxiliary intake width W8 as called out in FIG. 18. An auxiliary intake width ratio W8/W6 of the auxiliary intake width W8 to the overall air-guide width W6 is preferably in the range from 0.2 to 0.4, more preferably in the range from 0.24 to 0.36, and most preferably in the range from 0.27 to 0.33.

The front view combined air inlet area of the two air chamber intake ports 2514 plus the CVT duct inlet 2518 plus the combustion duct inlet 2519 is preferably in the range from 700 cm² to 1600 cm². A combined air inlet height H1 from the tops of the duct inlets 2518, 2519 to the bottoms of the air intake ports 2514 is preferably in the range from 650 to 1250 mm, more preferably in the range from 750 to 1150 mm, and most preferably in the range from 850 mm to 1050. Having the front view combined air inlet area and combined air inlet height H1 within these preferred ranges meets requirements of heat dissipation and combustion air volume, while still avoiding excessive width of the off-road vehicle 100.

The air-guide 251 is preferably made of plastic. Plastic material has the characteristics of being lightweight and corrosion resistant, and using plastic material as an air-guide 251 can reduce the weight of the vehicle 100 and improve its performance.

As shown in FIG. 18, the CVT 152 includes a CVT air outlet port 1521. The CVT air outlet port 1521 is positioned towards the rear to allow the exhaust of the CVT 152 to blow towards the turbocharger 191, exhaust pipe 192 and muffler 193. Locating and orienting the CVT air outlet port 1521 properly can increase the air flow at the rear of engine 151 and reduce the temperature of the turbocharger 191, exhaust pipe 192 and muffler 193, improving the heat dissipation efficiency of the rear of off-road vehicle 100.

FIG. 21 is a top plan view showing a preferred coolant reservoir 245 for inclusion in the cooling system 24. The coolant reservoir 245 includes a main body 2451, a pressure cap 2452, an engine-facing steam port 2453 for connection to the engine 151 through a coolant steam pipeline (not shown), a radiator-facing steam port 2454 for connection to the radiator 241 through a coolant steam pipeline (not shown), and a coolant fill port 2455 for replenishing liquid coolant to the radiator 241 through a larger coolant liquid recirculation pipeline (not shown). The engine-facing steam port 2453 and the radiator-facing steam port 2454 are generally toward the top of the main body 2451, while the coolant fill port 2455 is generally toward the bottom of the main body 2451. Diameters of the engine-facing steam port 2453 and the radiator-facing steam port 2454 are smaller than a diameter of the coolant fill port 2455.

The pressure cap 2452 is connected to the main body 2451 and includes a pressure valve (not separately shown) with bidirectional flow capability in fluid communication with external air. When pressure inside the main body 2451 is less than a first critical pressure threshold, the pressure cap 2452 (specifically, its pressure valve) opens, allowing airflow into the main body 2451. When pressure inside the main body 2451 is greater than the first critical pressure threshold but lower than a second critical pressure threshold, the pressure cap 2452 (specifically, its pressure valve) closes, sealing the coolant reservoir 245 from the external environment. At this time, the coolant fill port 2455 can ensure liquid level balance in the cooling system 26. The first critical pressure threshold is lower than the second critical pressure threshold. When pressure inside the main body 2451 is greater than the second critical pressure threshold, the pressure cap 2452 (specifically, its pressure valve) opens, allowing coolant steam and/or coolant to escape from the main body 2451. The first critical pressure threshold is preferably in the range from −10 to 0 kPa, more preferably in the range from −7 to −3 kPa, and most preferably in the range from −6 to −4 kPa. The second critical pressure threshold is preferably in the range from 90 to 170 kPa, more preferably in the range from 100 to 160 kPa, and most preferably in the range from 115 to 145 kPa. The operating coolant pressure within the engine 151 is ordinarily within the range from 0 kPa to 90 kPa.

The preferred coolant reservoir 245 can reduce the loss of coolant and improve the operational stability of the cooling system 24, balancing liquid level and pressure in the radiator 241 and the engine 151. During running of the off-road vehicle 100, coolant temperature will gradually increase, and coolant pressure will increase accordingly. High temperature and high pressure of coolant in the engine 151 can affect its performance and service life, particularly if the coolant boils, causing coolant steam bubbles and cavitation in the engine 151. Coolant steam can flow from the engine 151 into the main body 2451 through the engine-facing steam port 2453. Coolant steam can flow from the radiator 241 into the main body 2451 through the radiator-facing steam port 2454. The engine-facing steam port 2453 and the radiator-facing steam port 2454 only need to satisfy gas circulation, and their smaller diameters can reduce the space they occupy. When pressure in the coolant reservoir 245 exceeds the second critical pressure, excess coolant steam in the coolant reservoir 245 can be discharged into the environment, ensuring that coolant pressure within the engine 151 remains within an appropriate range, thereby improving reliable cooling of the engine 151. When the off-road vehicle 100 is turned off, coolant temperature will gradually decrease, and coolant pressure will decrease accordingly. Insufficient liquid coolant in the engine 151 can cause similar boiling/cavitation problems the next time the engine 151 heats up. The overall structure of the coolant reservoir 245 is simple and effective for enhanced cooling performance.

The coolant reservoir 245 is preferably positioned longitudinally behind one of the CVT duct inlet 2518 and the combustion duct inlet 2519, at about the same elevation and transverse position as that duct inlet 2518, 2519. Mounting the coolant reservoir 245 behind one of the duct inlets 2518, 2519 allows air entering that duct inlet 2518, 2519 to be used for heat dissipation from the coolant reservoir 245, thereby improving the overall heat dissipation efficiency of the cooling system 24.

It should be understood that for those skilled in the art, improvements or transformations can be made based on the above description, and all such improvements and transformations should fall within the scope of protection of the claims attached to the present application.

1. An off-road vehicle comprising:
a frame defining a cockpit and a longitudinal mid-plane of the off-road vehicle;
a plurality of wheels supporting the frame through a suspension system;
a vehicle body cover arranged on the frame;
a prime mover assembly supported by the frame behind the cockpit;
a drive train coupled between the prime mover assembly and at least some of the plurality of wheels to provide torque to at least some of the plurality of wheels for movement of the off-road vehicle;
a cooling system supported by the frame, the cooling system having a cooling module positioned above the prime mover assembly;
left and right vehicle doors connected to the frame providing access to the cockpit; and
an air-guide for guiding ambient air to the cooling module, the air-guide comprising:
an air-guiding housing having a rear air chamber portion with the cooling module at least partially positioned in the rear air chamber portion; and
at least one air chamber intake port positioned more rearwardly than and positioned further from the longitudinal mid-plane than one of the left and right vehicle doors, such that the one of the left and right vehicle doors guides air into and through the air chamber intake port to provide air to the rear air chamber portion of the air-guiding housing for airflow through the cooling module.

2. The off-road vehicle of claim 1, wherein the at least one air chamber intake port comprises:
a left air chamber intake port positioned more rearwardly than and positioned further from the longitudinal mid-plane than the left vehicle door; and
a right air chamber intake port positioned more rearwardly than and positioned further from the longitudinal mid-plane than the right vehicle door;
wherein each of the left air chamber intake port and the right air chamber intake port provides air therethrough to the rear air chamber portion of the air-guiding housing for airflow through the cooling module.

3. The off-road vehicle of claim 2, wherein the air-guide further comprises a ducting portion with a combustion duct inlet above one of the left and right air chamber intake ports, and wherein the off-road vehicle further comprises:
an air filter intake duct connected to provide airflow from the combustion duct inlet to an air filter.

4. The off-road vehicle of claim 3, wherein the air-guide further comprises one or more auxiliary air intake ports positioned at the front middle of the air-guiding housing behind the seats.

5. The off-road vehicle of claim 3, wherein the ducting portion comprises a CVT duct inlet above the other of the left and right air chamber intake ports, and wherein the off-road vehicle further comprises:
a CVT intake duct connected to provide airflow from the CVT duct inlet to a continuously variable transmission (CVT) of the prime mover assembly providing cooling air for the CVT.

6. The off-road vehicle of claim 1, wherein the off-road vehicle further comprises:
a CVT intake duct to provide airflow to a continuously variable transmission (CVT) of the prime mover assembly providing cooling air for the CVT.

7. The off-road vehicle of claim 1, wherein the air chamber intake port supplies air to the rear air chamber portion through an air chamber intake duct moving air inwardly and rearwardly toward the rear air chamber portion.

8. The off-road vehicle of claim 7, wherein an intake extension line is defined as an average between a centerline of the air chamber intake duct and a direction perpendicular to the air chamber intake port, wherein an air-guide longitudinal intake angle is defined between a horizontal component of the intake extension line and a longitudinal direction on the off-road vehicle, and wherein the air-guide longitudinal intake angle is in the range from 30 to 70°.

9. The off-road vehicle of claim 1, wherein the cooling module comprises an intercooler, a radiator positioned against the intercooler, and a fan assembly positioned to move air through both the intercooler and radiator.

10. The off-road vehicle of claim 9, wherein the fan assembly has a plurality of fans, wherein the cooling module defines a cooling module plane perpendicular to rotational axes of the plurality of fans, wherein a cooling module attack angle is defined between the cooling module plane and vertical, with the fan assembly blowing air rearwardly and upwardly, wherein the cooling module attack angle is in a range from 5 to 30°, wherein the fan assembly is positioned on a generally rear side of the radiator, and wherein the intercooler is positioned on a generally front side of the radiator; and wherein the cooling module further comprises a cooling module fixing bracket connected to the frame, the cooling module fixing bracket including a fan and radiator mounting surface supporting the fan assembly and the radiator and an intercooler mounting surface supporting the intercooler.

11. The off-road vehicle of claim 1, further comprising a fuel tank positioned forwardly of the cockpit, wherein the frame comprises a front frame having an upper front crossbeam supported by left and right forward posts and an upper rear crossbeam supported by left and right rearward posts, wherein the fuel tank is positioned longitudinally between the upper front crossbeam and the upper rear crossbeam, is positioned laterally between the left and right forward posts, and is positioned laterally between the left and right rearward posts, and such that the fuel tank extends across the longitudinal mid-plane.

12. The off-road vehicle of claim 1, wherein the drive train comprises a front drive shaft and a front differential, wherein the frame comprises a front frame having a front axle mount with left and right rear mounting ears and a front mounting crossbar, the front mounting crossbar extending across the longitudinal mid-plane such that during assembly, the front mounting crossbar can support the front differential during rearward sliding of the front differential between the left and right rear mounting ears into engagement with the front drive shaft.

13. The off-road vehicle of claim 12, wherein the front frame further comprises a front axle adapter bracket mounted to the front differential so as to extend upwardly from the front differential.

14. The off-road vehicle of claim 1, wherein the prime mover assembly comprises an engine, a continuously variable transmission (CVT) positioned substantially on one of left or right sides of the engine, a gear box positioned substantially rearward of the engine, and an auxiliary drive system substantially on another of the left or right sides of the engine opposite the CVT; and wherein the auxiliary drive system comprises a primary alternator and an auxiliary generator, wherein the auxiliary generator switches to a power generation state when electricity consumption of the off-road vehicle is greater than or equal to the preset threshold.

15. The off-road vehicle of claim 14, wherein the engine comprises an intake port oriented forwardly.

16. The off-road vehicle of claim 14, further comprising an air filter with a front-most end and a muffler with a rear-most end, wherein a longitudinal distance from the front-most end of the air filter to the rear-most end of the muffler is defined as a power package length, wherein the prime mover assembly is supported from the frame at least in part by a support cradle having at least three hangers, wherein a maximum longitudinal distance between elastic centers of the hangers of the support cradle is defined as a support cradle length, and wherein a power package/cradle length ratio of the power package length to the support cradle length is in the range from 1.3 to 1.9.

17. An off-road vehicle comprising:
a frame defining a cockpit;
a plurality of wheels supporting the frame through a suspension system;
a vehicle body cover arranged on the frame;
a prime mover assembly supported by the frame behind the cockpit;
a drive train coupled between the prime mover assembly and at least some of the plurality of wheels to provide torque to at least some of the plurality of wheels for movement of the off-road vehicle;
a cooling system supported by the frame, the cooling system having a cooling module positioned above the prime mover assembly, wherein the cooling module comprises an intercooler, a radiator positioned against the intercooler, and a fan assembly positioned to move air through both the intercooler and radiator;
left and right vehicle doors connected to the frame providing access to the cockpit; and
an air-guide for guiding ambient air to the cooling module, the air-guide comprising:
an air-guiding housing having a rear air chamber portion with the cooling module at least partially positioned in the rear air chamber portion; and
at least one air chamber intake port positioned rearwardly of one of the left and right vehicle doors, such that the one of the left and right vehicle doors guides air into and through the air chamber intake port to provide air to the rear air chamber portion of the air-guiding housing for airflow through the cooling module.

18. The off-road vehicle of claim 17, wherein the fan assembly has a plurality of fans, wherein the cooling module defines a cooling module plane perpendicular to rotational axes of the plurality of fans, wherein a cooling module attack angle is defined between the cooling module plane and vertical, with the fan assembly blowing air rearwardly and upwardly, wherein the cooling module attack angle is in a range from 5 to 30°, wherein the fan assembly is positioned on a generally rear side of the radiator, and wherein the intercooler is positioned on a generally front side of the radiator, wherein the cooling module further comprises a cooling module fixing bracket connected to the frame, the cooling module fixing bracket including a fan and radiator mounting surface supporting the fan assembly and the radiator and an intercooler mounting surface supporting the intercooler.

19. The off-road vehicle of claim 18, wherein the air-guide further comprises a ducting portion with a CVT duct inlet and with a combustion duct inlet, and wherein the off-road vehicle further comprises:
a CVT intake duct connected to provide airflow from the CVT duct inlet to a continuously variable transmission (CVT) of the prime mover assembly providing cooling air for the CVT; and
an air filter intake duct connected to provide airflow from the combustion duct inlet to an air filter.

20. An off-road vehicle comprising:
a frame defining a cockpit;
a plurality of wheels supporting the frame through a suspension system;
a vehicle body cover arranged on the frame;
a prime mover assembly having an engine with an intake port oriented forwardly, the prime mover assembly being supported from the frame at least in part by a support cradle having at least three hangers, wherein a maximum longitudinal distance between elastic centers of the hangers of the support cradle is defined as a support cradle length;
an air filter for filtering air for combustion in the engine, the air filter having a front-most end;
a muffler connected to the engine by an exhaust pipe, the muffler having a rear-most end, wherein a longitudinal distance from the front-most end of the air filter to the rear-most end of the muffler is defined as a power package length, wherein, and wherein a power package/cradle length ratio of the power package length to the support cradle length is in the range from 1.3 to 1.9;
a drive train coupled between the prime mover assembly and at least some of the plurality of wheels to provide torque to at least some of the plurality of wheels for movement of the off-road vehicle;
a cooling system supported by the frame, the cooling system having a cooling module positioned above the prime mover assembly;
left and right vehicle doors connected to the frame providing access to the cockpit; and
an air-guide for guiding ambient air to the cooling module, the air-guide comprising:
an air-guiding housing having a rear air chamber portion with the cooling module at least partially positioned in the rear air chamber portion; and
at least one air chamber intake port positioned rearwardly of one of the left and right vehicle doors, such that the one of the left and right vehicle doors guides air into and through the air chamber intake port to provide air to the rear air chamber portion of the air-guiding housing for airflow through the cooling module.
